(19) United States
(12) Patent Application Publication
(10) Pub. No.: US 2014/0149360 A1
(43) Pub. Date: May 29, 2014

(54) Usage of Filters for Database-Level Implementation of Constraints

(71) Applicant: SAP AG, Walldorf (DE)

(72) Inventors: Gregor Dieckmann, Walldorf (DE); Roland Kolata, Walldorf (DE); Ingo Raasch, Walldorf (DE)

(73) Assignee: SAP AG, Walldorf (DE)

(21) Appl. No.: 13/686,629

(22) Filed: Nov. 27, 2012

(51) Int. Cl. G06F 17/30

(52) U.S. Cl. CPC G06F 17/30289
USPC 707/690

(57) ABSTRACT

Embodiments relate to methods and apparatuses implementing database-level consistency checking in a declarative manner. A consistency engine within the database layer may access one or more consistency rules in the form of a table or executable program code. Based upon application of these consistency rules to records comprising combinations of data characteristics, the consistency engine may determine the validity or invalidity those records. Consistency rules may implement a ‘check’ method, and also a ‘derive’ method allowing derivation of data characteristics (targets) in a record from other characteristics (sources) in the record. Filters may be used to split data records to sets of records having all fields assigned, and those having ‘not assigned’ fields. Consistency rules used for derivation methods can be nested. Also, in certain embodiments a consistency engine may use filtering techniques for constraint checking including multi-level derivations in a declarative way.

### BACKGROUND

Embodiments of the present invention relate to storing data in a database, and in particular to systems and methods implementing consistency checking in a declarative manner at the database level.

Unless otherwise indicated herein, the approaches described in this section are not prior art to the claims in this application and are not admitted to be prior art by inclusion in this section.

Databases present in a database layer, store large volumes of data in an organized manner (for example in rows and columns) Analytical tools present in an application layer overlying the database layer, may allow a user access to data in the database.

Historically, data stored in databases has been used primarily for reporting purposes. Increasingly however, database data is also being accessed for forecasting or planning.

In using a database for such planning purposes, a user may seek to manipulate, modify, or enter data via the application layer. In this process, it can be important to check to see whether this data is in fact consistent (e.g. structurally, semantically) with the data of the underlying database.

Conventionally, such consistency was determined in a procedural manner, according to a series of instructions implemented in the separate application layer. In particular, relations were applied in the application layer on a single record level (methods ‘check’ and ‘derive’).

As database size has expanded rapidly, however, such approaches may be inefficient, and can degrade system performance. This is because the application layer is required to check the consistency of thousands or even millions of currently processed plan data records.

Accordingly, the present disclosure addresses these and other issues with methods and apparatuses implementing data consistency checking in a declarative manner at the database level.

### SUMMARY

Embodiments relate to methods and apparatuses implementing database-level consistency checking in a declarative manner. A consistency engine within the database layer may access one or more consistency rules in the form of a table or executable program code. Based upon application of these consistency rules to records comprising combinations of data characteristics, the consistency engine may determine the validity or invalidity those records. This means that the consistency rules implement a ‘check’ method.

In addition there may also exist consistency rules that implement a ‘derive’ method. These rules allow the derivation of data characteristics (targets) in a record from other characteristics (sources) in the record.

The consistency engine may also consider contexts where fields in data records that are to be checked, or from which targets are to be derived, are ‘not assigned’. In these cases, filters may be used to split data records to sets of records where consistency rules are applied, and where ‘not assigned’ fields are present.

Consistency rules used for derivation can be nested. In some embodiments, the consistency engine may use filtering techniques for constraint checking including multi-level derivations in a declarative way.

An embodiment of a computer-implemented method comprises causing a database engine in a database layer to receive an instruction from an application layer to create plan data, and causing a consistency engine in the database layer to declare a validity or an invalidity of the plan data based upon a consistency rule accessed in the database layer. Where the consistency engine declares a validity of the plan data, the database engine is caused to write the plan data to a persistency layer. Where the consistency engine declares an invalidity of the plan data, the database engine is caused to not write the plan data to the persistency layer.

An embodiment of a non-transitory computer readable storage medium embodies a computer program for performing a method. The method comprises causing a database engine in a database layer to receive an instruction from an application layer to create plan data, and causing a consistency engine in the database layer to declare a validity or an invalidity of the plan data based upon a consistency rule accessed in the database layer. Where the consistency engine declares a validity of the plan data, the database engine is caused to write the plan data to a persistency layer. Where the consistency engine declares an invalidity of the plan data, the database engine is caused to not write the plan data to the persistency layer.

An embodiment of a computer system comprises one or more processors and a software program executable on said computer system. The software program is configured to cause a database engine in a database layer to receive an instruction from an application layer to create plan data, and configured to cause a consistency engine in the database layer to declare a validity or an invalidity of the plan data based upon a consistency rule accessed in the database layer. Where the consistency engine declares a validity of the plan data, the database engine is caused to write the plan data to a persistency layer. Where the consistency engine declares an invalidity of the plan data, the database engine is caused to not write the plan data to the persistency layer.

In some embodiments the consistency engine may declare the validity based upon a filtering.

In certain embodiments, the filtering may comprise automatically declaring the validity where a field is not assigned.

In various embodiments, the data may be derived from a source characteristic, and the filtering comprises automatically declaring the validity where a field of the source characteristic is not assigned.

According to particular embodiments, the data is derived in multiple levels from a target characteristic, and the filtering comprises automatically declaring the validity where a field of the target characteristic is not assigned.

In some embodiments, the consistency engine may declare the invalidity based upon a filtering of a target field collision.

The following detailed description and accompanying drawings provide a better understanding of the nature and advantages of particular embodiments.

### BRIEF DESCRIPTION OF THE DRAWINGS

FIG. 1 is a simplified schematic view showing a system implementing consistency checking in accordance with an embodiment.

FIG. 1A is a simplified diagram illustrating flow of a consistency checking process according to an embodiment.

FIG. 2 is a simplified diagram illustrating the basic consistency principle with no derivation.

FIG. 3 is a simplified diagram illustrating the basic consistency principle with derivation.

FIG. 4 is a simplified diagram illustrating multi-level derivation.

FIG. 5 is a simplified diagram illustrating a target field collision.

FIG. 6 illustrates hardware of a special purpose computing machine configured to perform consistency checking according to an embodiment.

FIG. 7 illustrates an example of a computer system.

### DETAILED DESCRIPTION

Described herein are techniques for implementing consistency checking at the database level. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

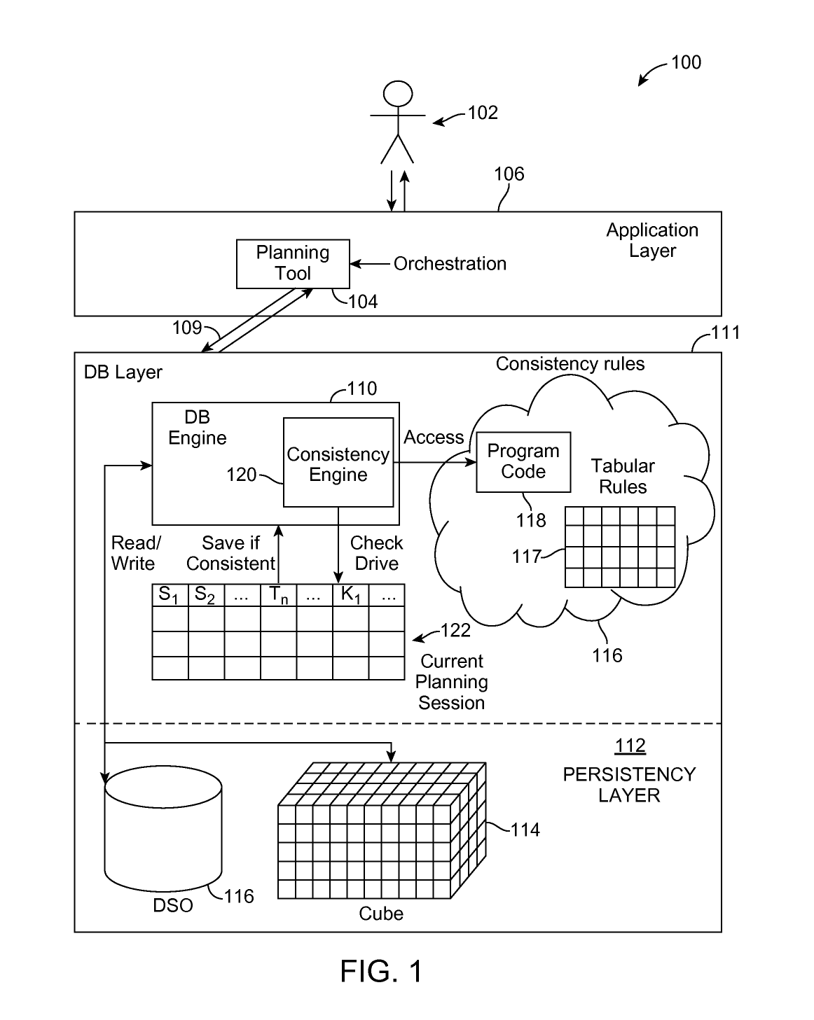

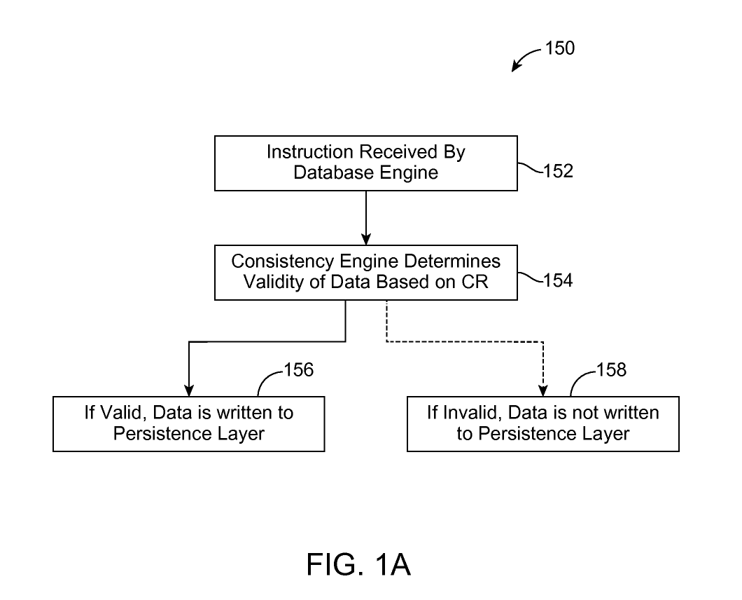

FIG. 1 shows a simplified view of a system 100 allowing utilization of a database for planning purposes. Specifically, a user 102 interacts with a planning tool 104 that is located in an application layer 106.

The planning tool allows orchestration of the data that will be employed in the planning function. In particular, the planning tool allows a user to create data for planning purposes. Such created data may represent the modification or deletion of data.

Based upon instructions 109 communicated from the planning tool to the database layer 111, a database engine 110 within the database layer in turn requests and works on plan data that resides within a planning persistence layer 112. In one particular example, the in memory HANA database available from SAP AG of Walldorf, Germany, may store plan data in the form of real-time InfoCubes 114 or DataStore-Objects (DSOs) 116.

Once read, the plan data can serve as a starting point for the user's interrogation, manipulation, and creation of additional data for planning purposes. Examples of such activity include the generation of forecasts and models of future activity.

Requested plan data may be described by filters. This data set is read from the databases, and may be aggregated and assigned to a planning session 122.

The data set comprises data records containing characteristics (Sᵢ, Tᵢ) and key figures (Kᵢ). From a number of available consistency rules, the system determines the set of consistency rules 116 that are relevant for the requested set of plan data in the planning session. Characteristics used in the requested plan data records may serve as source (Si) or target characteristics (Ti) with respect to the relevant consistency rules 116.

The plan data further comprises one or more key figures (K). A key figure represents a numerical measure. An example of a key figure could be a “budget in $” that is planned based on characteristics “Fiscal Year”, “Cost Center” and “Cost Center Responsible”.

Since planning is a controlled process, the consistency engine 120 ensures ‘data consistency’ between the data in the planning session and the relevant set of consistency rules 116. That is, the user should not seek to utilize plan data that is inconsistent with the structure, organizing principles, or semantics of the database and the set of consistency rules

To accomplish this, embodiments implement within the database layer, a consistency engine 120 that is a part of the database engine. This consistency engine is configured to recognize ‘constraints’ that records in the planning persistence layer have to fulfill.

According to particular embodiments, the consistency engine is configured to operate in a declarative manner. That is, the consistency engine is configured to access a set of pre-defined consistency rules (CRs) 116.

In certain embodiments, the consistency rules may be expressed in the form of one or more tables 117. In some embodiments, the consistency rules may be given as description in the form of executable program code 118.

The constraint rules may be explicitly modeled as part of the planning process. That is, some consistency rules may be determined according to planning objectives and methodologies provided by the planning tool.

Constraints can also be implied from use characteristics within the data of the underlying database. One type of such an implicit consistency rule is the generic consistency exhibited between different data characteristics relating to time. For example, the data characteristic “date” (e.g. Dec. 24, 2012) is implicitly related to the data characteristic “year” (e.g. 2012).

Another example of a constraint could preclude manipulation, modification, or entry of data by a user, that would generate a plan data record including mutually exclusive characteristics (e.g.“black” AND “white”) that could violate a basic structural principle of the underlying database. Semantic principles could form yet another basis for a constraint to be expressed in a declarative manner as a CR implemented at the database level.

One or more filtering techniques may be employed in consistency checking according to various embodiments. As is discussed in detail in connection with the Example, below, one type of filter may identify a set of records automatically valid with respect to a relation, if at least one field of the relation is ‘not assigned’. Another type of filter may identify a set of records automatically valid with respect to a derivation relation if a data field is ‘not assigned’; a derivation relation cannot fill characteristics if at least one source characteristic is ‘not assigned’. Other filters may also apply for constraint checking in multi-level derivation, and to identify a set of records where a target collision might occur.

Based upon application of consistency checking in a declarative manner according to embodiments, a result of either validity (indicating consistency) or invalidity (indicating inconsistency) is returned by the consistency engine of the database layer. As shown in FIG. 1 plan data that is declared to be valid (consistent) according to the CRs, is caused to be written to the persistence layer by the DB engine.

By contrast, plan data that is declared to be invalid (inconsistent) according to the CRs is not allowed. Thus, the planning system does not allow creation (e.g. via manual user input) of records of plan data that are not consistent with the constraints reflected by the CRs. While such inconsistent data may be entered by a user into a current planning session 122, that data is promptly checked as described herein. If declared inconsistent according to the CRs, that data is rejected as invalid by the system and is not submitted by the DB engine for writing to a plan data buffer within the persistence planning layer.

Constraints may change over time. For example, the individual responsible for a particular cost center may leave, be promoted, etc. As a result, existing plan data may have to be realigned according to the new constraints. This realignment may also include the deletion of invalid plan data. Accordingly, embodiments provide for modification of CRs stored in the database layer and accessed by the consistency engine at the database level.

FIG. 1A is a simplified diagram illustrating the flow of a consistency checking process 150 according to an embodiment. In a first step 152, a database engine receives an instruction from a planning tool to manipulate, modify, or enter data. In a second step 154, the consistency engine at the database level accesses a consistency rule to determine validity of the data. In a third step 156, where the data is declared valid by the consistency engine, the data is written by the database engine to a persistence layer. In step 158, where the data is declared invalid by the consistency engine, the data is not written to the persistence layer.

As previously mentioned, consistency checking implemented in a declarative manner at the database level according to various embodiments, may employ one or more filtering techniques. Such filtering is now discussed below.

### EXAMPLE

A particular example of ensuring consistency of the persistency layer with respect to relations by mass checks and derivations, is now described. This particular example comprises performing mass checks and derivations according to the characteristics relations definition on the HANA in-memory database available from SAP AG of Walldorf, Germany. Plan data is generated from this HANA database using the Business Warehouse (BW) Integrated Planning tool also offered by SAP AG. However, embodiments are not limited to this particular planning tool or database type.

Contextual information relating to this specific example is now provided. The BW Integrated Planning tool in conjunction with the HANA database, uses real-time InfoCubes or DataStore-Objects (direct update) to store plan data. According to embodiments, constraints may be implemented using checks on data records. With HANA as a database, mass consistency checks may be implemented with respect to the existing constraints by using conditional filtering techniques in a declarative way.

Constraints are given by a set of relations defined on the persistency layer (i.e. per InfoCube or direct update DataStore-Object). A single relation is defined by a set of characteristics (fields) used in the persistency layer.

A relation can be of two types. A no derivation relation defines whether characteristic value combinations (CVCs) for the characteristics used in the relation are admissible or not.

A relation with derivation indicates that characteristics in the relation can have either the role of a source characteristic, or of a target characteristic. The relation with derivation type, is able to derive characteristics values for all target characteristics if values for the source characteristics are known (filled).

In this sense, the derivation is a function defined on admissible CVCs of the source characteristics. One combination of values with respect to the source characteristics is mapped to at most one combination of values for the target characteristics.

A derivation relation also defines a consistency check if source fields of the relation and at least one target field of the relation are filled. The target fields of the relation may be derived, and whether the known target fields were not changed is checked Implicitly-given generic relations, are of the type with derivation.

BW Integrated Planning uses the InfoProvider ‘Aggregation Level’ to structure the persistence layer. The Aggregation Level includes by definition, a set of characteristics and key figures. Records stored in the persistence layer come from aggregation levels.

Characteristics not contained in the Aggregation Level are aggregated. That is, key figure values are aggregated with respect to these fields by the aggregation functions SUM, MIN, MAX or NO2 (no aggregation or the unique value if MIN=MAX).

Consistency checks according to various embodiments may be implemented as follows. CVCs in an Aggregation Level are consistent with respect to existing relations in the persistence layer. That is, relevant relations of the above mentioned types will be applied to records of the aggregation level to check data consistency. A relation is relevant for an aggregation level, if all needed fields of the relation are included in the Aggregation Level.

In this particular example, derivation is handled as follows. Before records will be stored, characteristic values for characteristics not contained in the Aggregation Level will be derived using all relevant derivation relations. A derivation relation is relevant for an Aggregation Level if all source characteristics of a relation can be filled by the Aggregation Level or by a preceding derivation relation.

In addition a target characteristic has to be filled by the relation that is not contained in the Aggregation Level. Thus a chain of derivations is possible.

Characteristics not filled by a derivation relation are empty, i.e. ‘not assigned’. This is to be interpreted as ‘not assigned’ with respect to the dimension spanned by this characteristic.

A basic consistency principle for this example is as follows. All Aggregation Levels are admissible. There exists no modeled ‘hierarchy’ of Aggregation Levels. As constraints are defined by relations for real-time InfoCubes or direct update DataStore-Objects, a record is consistent with respect to the persistence (not with respect to Aggregation Levels).

In other words, the consistency does not depend on the Aggregation Level. This has the consequence that data records (CVCs) containing ‘not assigned’ values are ‘automatically valid’.

In this example, the following defines an ‘automatically valid’ record with respect to a relation. For a no derivation type, a record is automatically valid with respect to a relation if at least one field of the relation is ‘not assigned’.

For a type with derivation, a record is automatically valid with respect to a derivation relation if at least one source field is ‘not assigned’. A derivation relation cannot fill target characteristics if at least one source characteristic is ‘not assigned’.

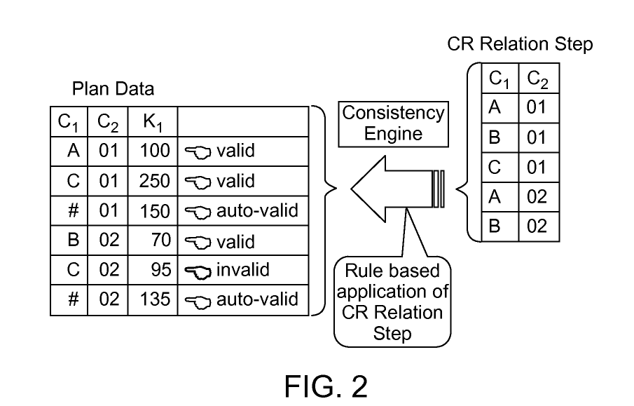

FIG. 2 is a simplified view illustrating the basic consistency principle of the no derivation type, in connection with a sample current planning session. In particular, C1 and C2 are characteristics of the data, and K1 is a key figure. Rule based application of a CR relation step in a declarative manner by the consistency engine at the database level, is shown.

Again, while consistency rules are depicted here as a table, this is not required. Rules could alternatively be given as description in the form of executable program code.

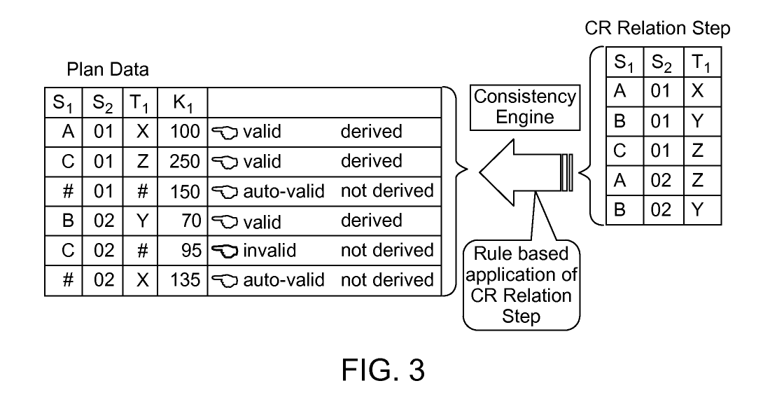

FIG. 3 is a simplified view illustrating the basic consistency principle of the type with derviation, in connection with another sample current planning session. S1 and S2 are source characteristics, T1 is a derived target characteristic, and K1 is a key figure.

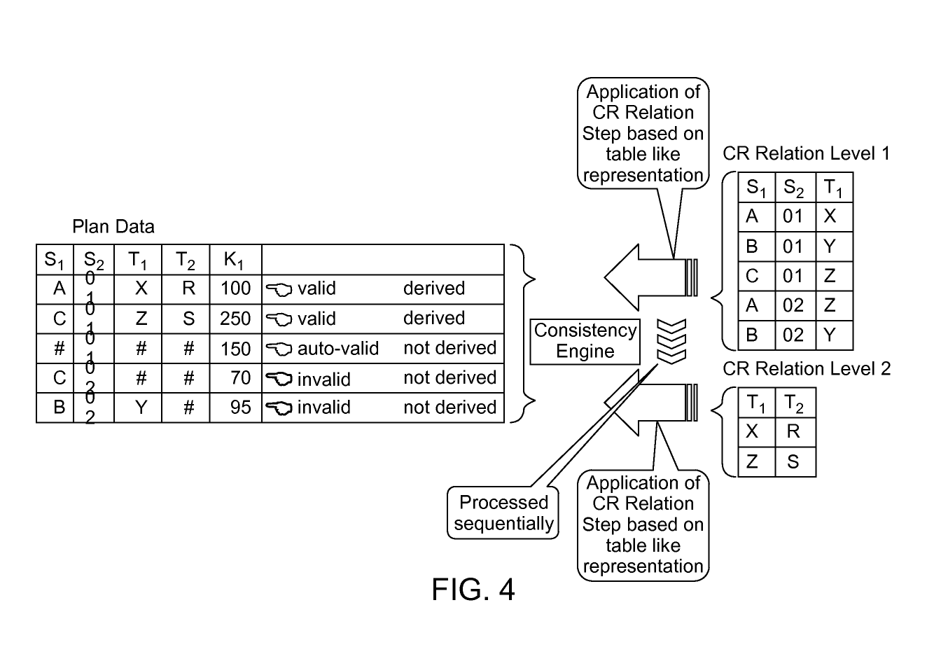

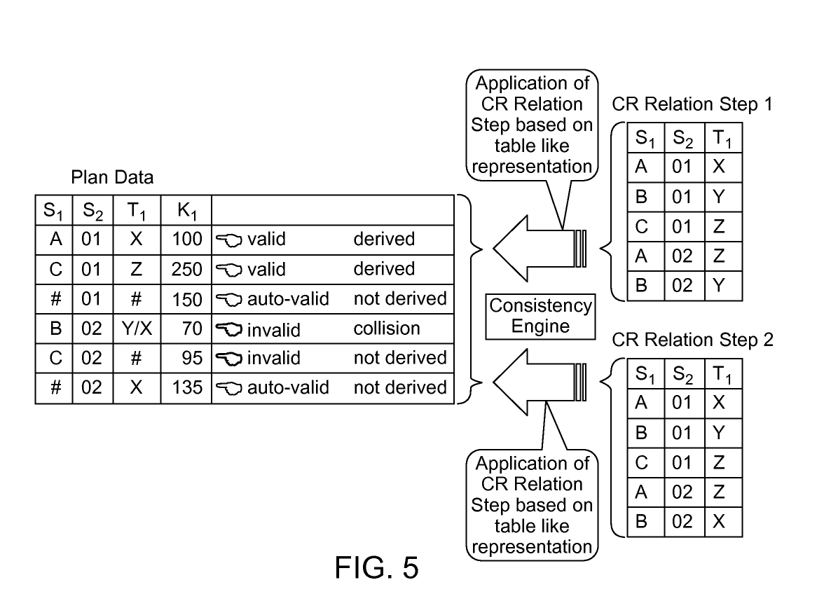

FIG. 3 again shows rule based application of a CR relation step in a declarative manner by the consistency engine in the database layer. In this FIG. 3 (as well as in the following FIGS. 4-5), a ‘not assigned’ (i.e. initial) value within a CVC is explicitly expressed by the ‘#’ symbol.

Constraints may be implemented on the database level using filters. As previously mentioned, ‘planning constraints’ are given by relations. Consistency may be ensured by performing one or more of the following tasks.

One task is to check for consistency with respect to existing relations. That is, given a set of records in a planning session on the HANA database, the set is checked for consistency with respect to existing relations.

Another task is to check for consistency with respect to derived relations. That is, given a set of records in a planning session on the HANA database, a chain of possible derivation relations is applied.

According to embodiments, these mass checks and derivations may be applied in the database layer. Certain embodiments may assume a table-like representation of steps of the characteristic relation (i.e. a table of the valid records with respect to the step).

In this representation, the characteristic relation can be seen as some kind of foreign key relationship between the set of plan data and the table-like representation of the step. In addition, the concept of automatically valid records has to be implemented making an enhancement of the foreign key relationship representation necessary.

In the context of derivation, two special aspects may be accounted for. First, as mentioned above derivations can line up to form derivation chains. Such chains introduce levels of derivation steps to be executed in a sequential way, because the result of the predecessor serves as the input for the successor. FIG. 3 shows a simplified diagram of a filtering approach that may be used for consistency checking for such multi-level derivations.

A second aspect that may relate to derivations is that target fields of relations do not necessarily have to be pairwise disjunct. As a consequence, a field might be target of derivation chains following different paths, maybe even on different levels of derivation steps.

Accordingly, in certain embodiments consistency indicates that that possible derivation paths for a specific target field lead to the same characteristic value for the field (detect target field collisions). FIG. 4 shows a simplified diagram of a filtering approach which may be used for consistency checking in the context of a target field collision.

Consistency checking according to various embodiments may bridge a gap between requirements for data consistency on the one hand, and performance requirements on the other hand. Such a gap may become apparent in handling large amounts of very granular plan data on an aggregated level. One example of such an environment is when end users are offered only a few data records through specialized user interfaces (UIs), but may end up changing substantial volumes of detailed plan data with every input.

Filtering may be used to separate ‘automatically valid’ CVCs not covered by the consistency requirement introduced by a characteristics relation step, from CVCs that are to be checked or used as input for derivation. In an embodiment a filter may be defined only based on metadata in order to provide a fully declarative formulation of the characteristic relation. Such a filter may filter all CVCs being ‘automatically valid’.

Various algorithms for ensuring data consistency may exist. Certain embodiments may be executed in two phases:

1. steps defining the applicable consistency constraints are assembled and added to an execution queue; and
2. the queue is flushed, delegating the execution of the required consistency constraints to SAP HANA for high performance mass data execution.

This two phase approach may introduce additional performance characteristics. In particular, step 1. may be executed only once during design time. This stores the constraint definition as an attribute to the planning model that is statically taking care of plan data consistency in SAP HANA without further interaction with the planning application.

A sketch of the declarative representation of derivations in the context of SAP HANA is now given as follows.

In a first use case a target field is derived for the first time (no target field collision) and all source fields of the relation are contained in the Aggregation Level (level 0 derivation). Here, added to the queue may be a derivation for all CVCs not being automatically valid (i.e. not having one characteristic with value ‘not assigned’ as source).

In a second use case a target field is derived for the next (second, . . . ) time (target field collision) and source fields of the relation are contained in the Aggregation level (level 0 derivation). Here, added to the queue is a derivation for all CVCs not being automatically valid and not derived in the directly preceding derivation step for this target field. Added to the queue is a check for all CVCs not being automatically valid and omitted in the corresponding derivation step for this target field.

In a third use case a target field is derived and at least one source field is the target of a preceding derivation step (multi level derivation). The maximum level assigned to all preceding derivation steps is found, and this level is assigned increased by one to the current derivation step. Here, the steps described in the first scenario are performed if the field is derived for the first time (no target field collision). The steps described in the second scenario are performed if the field is derived for the next (second, . . . ) time (target field collision).

In a fourth use case the queue level is flushed by level delegating the execution of the defined derivations to SAP HANA.

The following provides a sketch of the declarative representation of checks in the context of SAP HANA. Since no multi level execution has to be taken care of, and no data is changed by the checks the algorithm, executing checks is straight forward.

First, for every field that is contained in the characteristics relation step, added to the queue is a check for all CVCs not being automatically valid (i.e. not having one characteristic with value ‘not assigned’). Second, flush the queue in a single step delegating the execution of the defined derivations to SAP HANA.

Methods and apparatuses according to various embodiments may offer certain benefits. For example, some embodiments may leverage the processing power present in the database layer of in-memory databases, to perform rapid and efficient consistency checking in a declarative manner. Examples of such in memory databases include the HANA database just mentioned, as well as the SYBASE IQ database also available from SAP AG; the Microsoft Embedded SQL for C (ESQL/C) database available from Microsoft Corp. of Redmond, Wash.; and the Exalytics In-Memory database available from Oracle Corp. of Redwood Shores, Calif.

However, while the particular Example has focused upon use of declarative consistency checking implemented in the database layer of an in memory database, embodiments are not limited to this particular environment. Alternative embodiments could employ consistency checking in a declarative manner at the database level (e.g. utilizing CRs) in conjunction with disk-based databases.

Moreover, while the particular Example has focused upon use of the SAP BW Integrated Planning tool in conjunction with the HANA database, embodiments are not limited to use with this or any specific planning tool. Other types of planning tools that are configured to interact with a database (which may be in memory or disk-based), may also rely upon consistency checking implemented in a declarative manner at the database level.

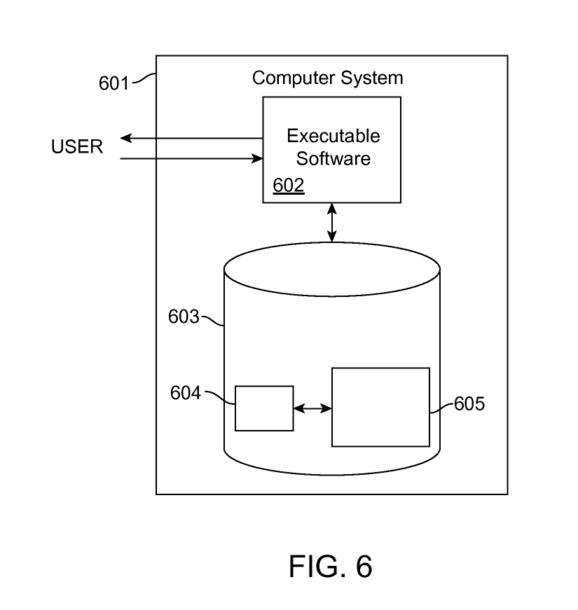

FIG. 6 illustrates hardware of a special purpose computing machine configured to perform consistency checking according to an embodiment. In particular, computer system 600 comprises a processor 602 that is in electronic communication with a non-transitory computer-readable storage medium 603. This computer-readable storage medium has stored thereon code 605 corresponding to a consistency engine. Code 604 corresponds to a database engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

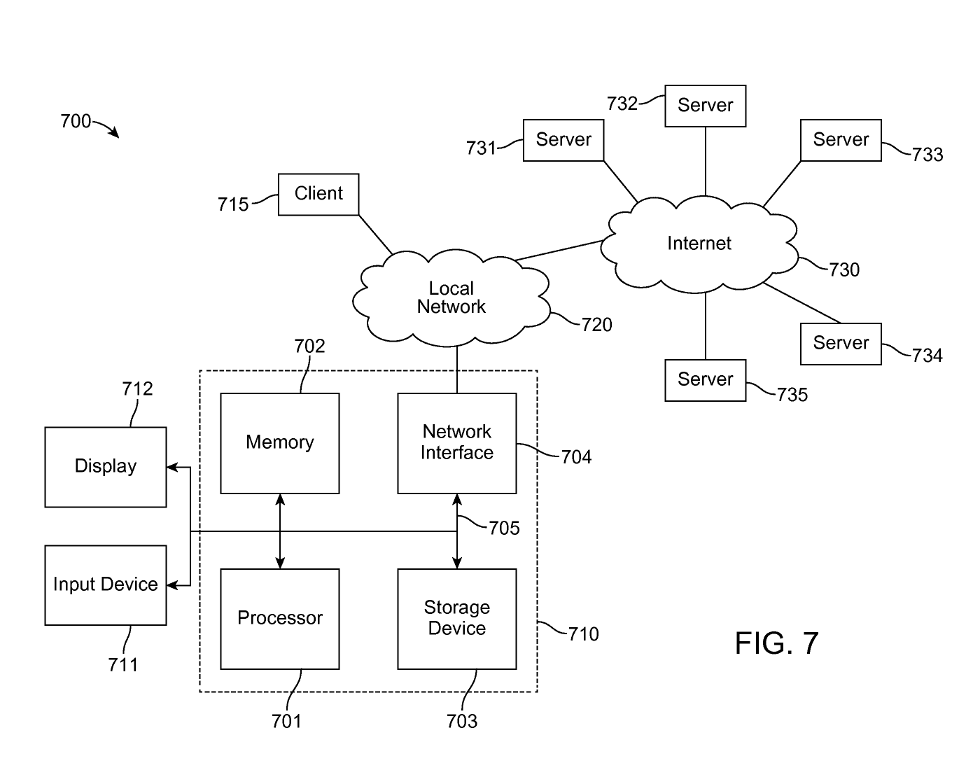

An example computer system 710 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing a database engine in a database layer to receive an instruction from an application layer to create plan data;
causing a consistency engine in the database layer to declare a validity or an invalidity of the plan data based upon a consistency rule accessed in the database layer;
where the consistency engine declares a validity of the plan data, causing the database engine to write the plan data to a persistency layer; and
where the consistency engine declares an invalidity of the plan data, causing the database engine to not write the plan data to the persistency layer.

2. A method as in claim 1 wherein the consistency engine declares the validity based upon a filtering.

3. A method as in claim 2 wherein the filtering comprises automatically declaring the validity where a field is not assigned.

4. A method as in claim 2 wherein the data is derived from a source characteristic, and the filtering comprises automatically declaring the validity where a field of the source characteristic is not assigned.

5. A method as in claim 2 wherein the data is derived in multiple levels from a target characteristic, and the filtering comprises automatically declaring the validity where a field of the target characteristic is not assigned.

6. A method as in claim 1 wherein the consistency engine declares the invalidity based upon a filtering of a target field collision.

7. A method as in claim 1 wherein the consistency rule comprises a table or executable program code.

8. A non-transitory computer readable storage medium embodying a computer program for performing a method, said method comprising:
causing a database engine in a database layer to receive an instruction from an application layer to create plan data;
causing a consistency engine in the database layer to declare a validity or an invalidity of the plan data based upon a consistency rule accessed in the database layer;
where the consistency engine declares a validity of the plan data, causing the database engine to write the plan data to a persistency layer; and
where the consistency engine declares an invalidity of the plan data, causing the database engine to not write the plan data to the persistency layer.

9. A non-transitory computer readable storage medium as in claim 8 wherein the consistency engine declares the validity based upon a filtering.

10. A non-transitory computer readable storage medium as in claim 9 wherein the filtering comprises automatically declaring the validity where a field is not assigned.

11. A non-transitory computer readable storage medium as in claim 9 wherein the data is derived from a source characteristic, and the filtering comprises automatically declaring the validity where a field of the source characteristic is not assigned.

12. A non-transitory computer readable storage medium as in claim 9 wherein the data is derived in multiple levels from a target characteristic, and the filtering comprises automatically declaring the validity where a field of the target characteristic is not assigned.

13. A non-transitory computer readable storage medium as in claim 8 wherein the consistency engine declares the invalidity based upon a filtering of a target field collision.

14. A non-transitory computer readable storage medium as in claim 8 wherein the consistency rule comprises a table or executable program code.

15. A computer system comprising:
one or more processors;
a software program, executable on said computer system, the software program configured to:
cause a database engine in a database layer to receive an instruction from an application layer to create plan data;
cause a consistency engine in the database layer to declare a validity or an invalidity of the plan data based upon a consistency rule accessed in the database layer;
where the consistency engine declares a validity of the plan data, causing the database engine to write the plan data to a persistency layer; and
where the consistency engine declares an invalidity of the plan data, causing the database engine to not write the plan data to the persistency layer.

16. A computer system as in claim 15 wherein the consistency engine declares the validity based upon a filtering.

17. A computer system as in claim 16 wherein the filtering comprises automatically declaring the validity where a field is not assigned.

18. A computer system as in claim 16 wherein the data is derived from a source characteristic, and the filtering comprises automatically declaring the validity where a field of the source characteristic is not assigned.

19. A computer system as in claim 16 wherein the data is derived in multiple levels from a target characteristic, and the filtering comprises automatically declaring the validity where a field of the target characteristic is not assigned.

20. A computer system as in claim 15 wherein the consistency engine declares the invalidity based upon a filtering of a target field collision.
